(19) United States
(12) Patent Application Publication
(10) Pub. No.: US 2022/0156514 A1
(43) Pub. Date: May 19, 2022

(54) VIDEO REPRESENTATION LEARNING

(71) Applicant: QUALCOMM Technologies, Inc., San Diego, CA (US)

(72) Inventors: Kirill GAVRILYUK, Amsterdam (NL); Mihir JAIN, Amsterdam (NL); Cornelis Gerardus Maria SNOEK, Volendam (NL)

(21) Appl. No.: 17/454,743

(22) Filed: Nov. 12, 2021

Related U.S. Application Data
(60) Provisional application No. 63/113,742, filed on Nov. 13, 2020.

(51) Int. Cl. G06K 9/62; G06K 9/46; G06K 9/00; G06N 3/08

(52) U.S. Cl. CPC G06K 9/6256; G06K 9/46; G06N 3/08; G06K 9/00979; G06K 9/6218

(57) ABSTRACT

Certain aspects of the present disclosure provide techniques for training a first model based on a first labeled video dataset; generating a plurality of action-words based on output generated by the first model processing motion data in videos of an unlabeled video dataset; defining labels for the videos in the unlabeled video dataset based on the generated action-words; and training a second model based on the labels for the videos in the unlabeled video dataset.

### CROSS-REFERENCE TO RELATED APPLICATIONS

This application claims the benefit of and priority to U.S. Provisional Patent Application No. 63/113,742, filed on Nov. 13, 2020, the entire contents of which are incorporated herein by reference.

### INTRODUCTION

Aspects of the present disclosure relate to systems and methods for learning video representations without manual labeling.

Training machine learning models, such as deep convolutional neural network models, to perform recognition tasks based on video data streams is an inherently complex task, which is made more difficult when there is limited training data. Training data for such models may generally be in short supply because of the significant amount of manual time and effort required to generate the training data. For example, generating training data for video recognition tasks may requires a human to watch a significant amount of video content and to label (or annotate) the videos so that they may then be used by a learning algorithm. Without sufficient training data, video recognition models do not achieve their full representative potential.

Accordingly, what are needed are systems and methods for generating training data in an unsupervised manner, which can be used to improve the training of machine learning models.

### BRIEF SUMMARY

Certain aspects provide a method for training a first model based on a first labeled video dataset; generating a plurality of action-words based on output generated by the first model processing motion data in videos of an unlabeled video dataset; defining labels for the videos in the unlabeled video dataset based on the generated action-words; and training a second model based on the labels for the videos in the unlabeled video dataset.

Other aspects provide processing systems configured to perform the aforementioned methods as well as those described herein; non-transitory computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts example operations for semi-supervised computer vision model training.

FIG. 2 depicts example operations for generating action-words for training a computer-vision model.

FIG. 3 depicts example operations for training a model based on self-generated training data.

FIG. 4 depicts example operations for refining a model trained on self-generated training data.

FIG. 5 depicts an example method for training a computer vision model using self-generated training data.

FIG. 6 depicts an example processing system that may be configured to train and use a computer vision model as described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating training data in an unsupervised manner.

Supervised machine learning techniques may be particularly adept for many computer vision tasks, like image recognition, object detection, and video action recognition, to name just a few examples. Pre-training computer vision models on large datasets, like ImageNet and Kinetics, has become a conventional approach for many types of computer vision tasks. However, obtaining large labeled video datasets remains difficult and time-consuming, which limits the overall performance of computer vision models. Further, the ability for models to discriminate a wide variety of video data is ultimately limited by the limited availability of labeled training data.

Unsupervised learning techniques can provide an alternate mechanism for obtaining labeled video data for training computer vision models. Some methods for using unlabeled video datasets may include exploiting context, color, or spatial ordering in video data to generate features for training computer vision models. However, generating features of a higher semantic level of representations may improve the training and thereby the performance of computer vision models.

Embodiments described herein utilize unsupervised learning to segment video data into action sequences (or “pseudo-actions”) that have meaningful beginnings and ends, and which may be referred to as “action-words” of a “sentence” characterizing the entire video sequence. For example, a video depicting a baseball game may include a sequence showing the pitcher winding up and throwing a pitch, then another sequence showing the batter tracking the ball and hitting it, and then a final sequence showing players fielding the ball. Each of these sequences has a discrete beginning and end, and thus each is an individual action-word.

In some embodiments, the unsupervised learning is based on motion data derived from video data, rather than on the image data itself. For example, optical flow or optic flow refers to a determinable pattern of apparent motion of objects, surfaces, and edges in a visual scene caused by the relative motion between an observer and a scene. Optical flow techniques may be used to generate motion data, which may in-turn be used for determining action-words in unlabeled (or unannotated) video data.

Embodiments described herein then utilize self-supervised (or self-learning) to learn spatiotemporal features in unlabeled video data by localizing action-words in unlabeled video data. The resulting models may be used to perform various tasks based on video data, such as classification, localization, and sequence prediction.

Beneficially, autonomous action-word generation allows for generating large amounts of labeled video data, which can be used to train more accurate machine learning models, such as computer-vision models.

### Semi-Supervised Computer Vision Model Training

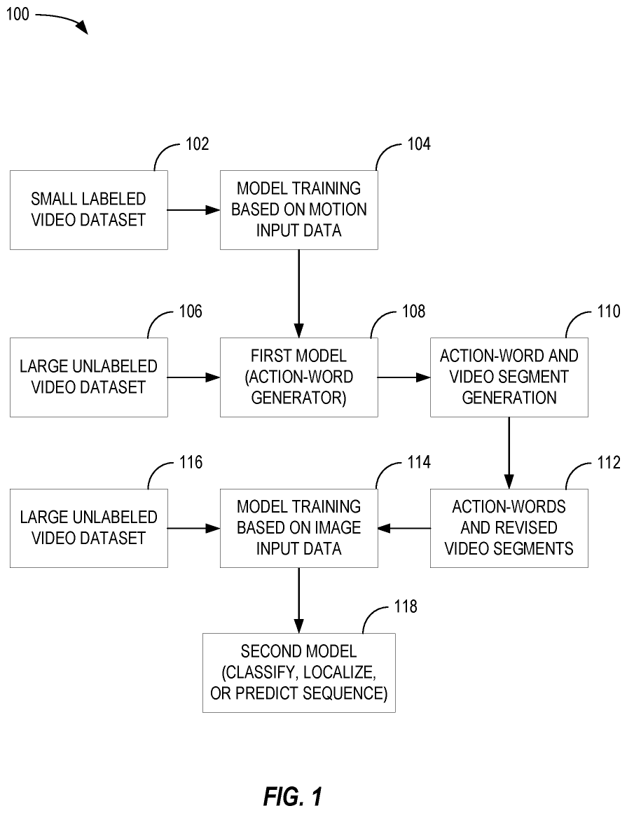

FIG. 1 depicts example operations 100 for semi-supervised computer vision model training.

Initially, a relatively smaller labeled video dataset 102 is used for performing supervised model training 104 to generate a first model 108, which in this example may be referred to as an action-word (or pseudo-label) generator model. In some embodiments, first model 108 may be a machine learning model, such as a convolutional neural network model. In some cases, small labeled video dataset 102 may have 10,000 or fewer samples. Using a relatively smaller labeled video dataset, such as 102, may beneficially shorten the time and compute power needed to initialize first model 108.

As in this example, model training at 104 may be performed based on motion input data derived from small labeled video dataset 102, such as by using an optical flow method. Training on motion input beneficially improves the performance of the action-word generation as compared to training based on the underlying image data (e.g., frames of RGB image data). However, it is also possible to initialize first model 108 using image data.

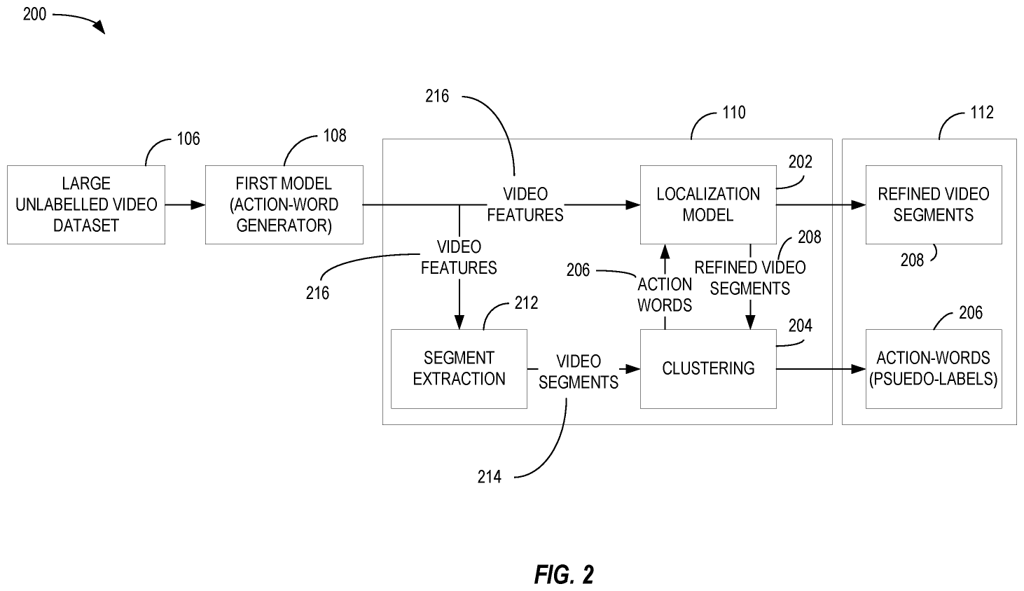

First model 108 may then process a relatively larger (e.g., larger than labeled video dataset 102) unlabeled video dataset 106 and generate output in the form of video features. The video features output by first model 108 may then be processed by action-word and video segment generation process 110 to generate action-words and revised video segments 112. Action-word and video segment generation process 110 is described in more detail below with respect to FIG. 2.

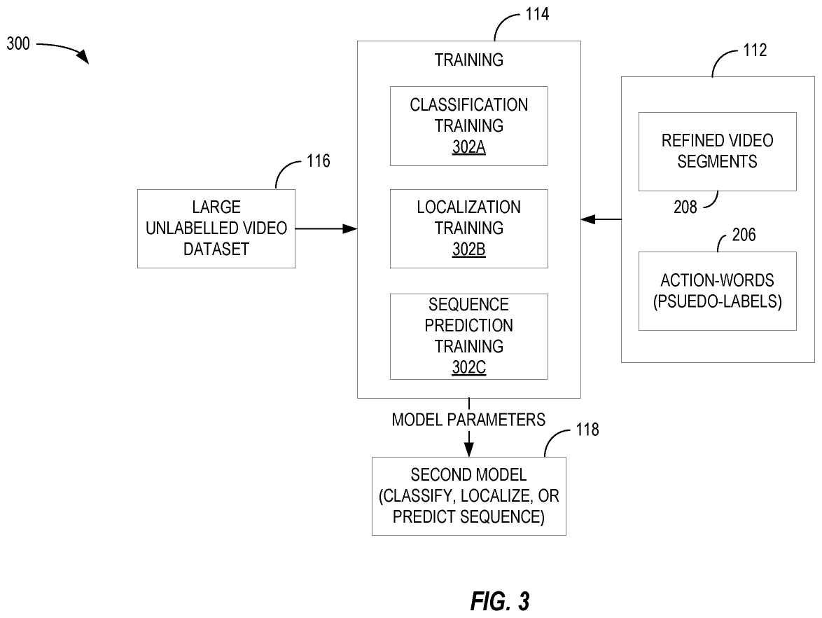

Action-words and revised video segments 112 are then used in conjunction with a relatively larger unlabeled video dataset 116 (e.g., larger than labeled video dataset 102) for training a second model at step 114 for one or more specific tasks, such as classification, localization, and sequence prediction, which are all based on the action-words and/or video segments 112. Notably, here action-words and video segments 112 are acting as self-generated labels (or “pseudo-labels”) for model task training step 114, which obviates the need for a human to review and manually label the videos in large unlabeled video dataset 116. Thus, second model 118 is being “self-trained” (e.g., via semi-supervised learning) based on its own generated label data (such as the generated action-words and refined video segments 112). Model task training is discussed in further detail below with respect to FIG. 3.

Note that in some embodiments, large unlabeled video dataset 116 is different than large unlabeled video dataset 106, while in other embodiments it is the same.

The result of model task training step 114 is a second, self-trained model 118, which may perform tasks, such as classification, localization, and sequence prediction. Beneficially, here second model 118 may have improved performance (e.g., accuracy) based on being trained on a larger unlabeled dataset 116 using self-generated labels without a human having to review and label all of the videos in large unlabeled dataset 116 and without having to rely on the availability of smaller labeled video datasets, such as 102, for the task training.

Thus, method 100 beneficially allows high-performance computer vision models to be trained in a semi-supervised manner on any large video dataset without the need for manual, time-consuming, and error-prone manual labelling. This method makes virtually any large video dataset useful for training models to perform various machine learning tasks, whereas conventional methods relied on scarcely available and significantly smaller labeled video datasets, which resulted in models with generally less generalization and accuracy.

### Example Operations of Self-Generating Action-Words for Training

FIG. 2 depicts example operations 200 for generating action-words and (optionally) revised video segments for training a computer-vision model.

As in FIG. 1, after initialization, first model 108 may process unlabeled video dataset 106 to generate video features 216 as output, which then are provided as inputs to action-word and video segment generation process 110.

In one aspect, video features 216 are provided to segment extraction process 212, which uses the features to extracts video segments 214 based on the video data input to first model 108. Generally, an extracted video-segment has vectors associated with its time steps, and the average of these vectors is a vector representing the video-segment.

The extracted video segments 214 are then provided to a clustering model (or process) 204, which performs clustering on the extracted video segments to determine action-words (or pseudo-labels) 206. Each action-words 206 is generally representative of the video segments in its cluster, such as the centroid of the cluster. In some embodiments, clustering process 204 comprises an unsupervised clustering process, such as k-means. In such embodiments, the number of action-words 206 is the same as the number of means, k, generated by clustering process 204.

Action-words (or action words) 206 are thus output from action-word and video segment generation process 110 and part of action-words and refined video segments 112 (as in FIG. 1). In some embodiments, action-words 206 may further be used to train localization model 202, as indicated by the arrow between clustering process 204 and localization model 202. That is, the same action-words 206 that are provided as part of output action-words and refined video segments 112 can also be used for training localization model 202. Localization model then takes video features 216 as an input and generates refined video segments 208 as an output. Generally, refined video segments 208 have more meaningful boundaries compared to the original video segments 214 extracted by segment extraction process 212. In some embodiments, localization model 202 is a weakly-supervised temporal activity localization model.

As depicted, an iterative improvement cycle may be performed between clustering 204 and training localization model 202 and outputting refined video segments 208 from localization model 202. Generally, every time localization model 202 is trained, it leads to more refined video segments 208, which in-turn are used to improve the action-words through clustering 204, which then improves the video segmenting via localization model 202, and so on. At the end of this iterative training, a sequence of refined video-segments 208 is determined for each video in unlabeled video dataset 106 and action-words 206 are assigned to each segment 214 in each video.

Note that the iterative improvement process performed between clustering 204 and localization model 202 to generate the refined video segments 208 is an optional step to improve the overall process described with respect to FIG. 1. Other embodiments may omit this aspect and determine action-words 206 and video segments 208 as the output of process 110. Such embodiments may have faster processing times as the expense of some ultimate model accuracy.

### Example Operations for Training a Model Based on Self-Generated Training Data

FIG. 3 depicts example operations 300 for training a model based on self-generated training data, such as described with respect to FIG. 2, which may include action-words 206 and refined video segments 208. Note that in this example, refined video segments 208 are used, but as above, video segments 214 may alternatively be used in embodiments omitting the video segment refinement process.

As depicted, unlabeled video dataset 116 may be used in conjunction with the self-generated action-words 206 (pseudo-labels) and (optionally) refined video segments 208 to train second model 118 to perform various tasks, such as classification 302A, localization 302B, and sequence prediction 302C (e.g., the prediction of a next action-word in a video sequence given a current action-word), to name a few.

In this embodiment, second model 118 is trained (via process 114) based on video (or image) data (e.g., RGB image frames in video data) in large unlabeled video dataset 116, rather than based on motion data such as with the training of first model 108 in FIG. 1. However, in other embodiments, motion data based on the videos in large unlabeled video dataset 116 may also be used.

In some embodiments, second model 118 may be a neural network model and training operation 114 may be performed using a backpropagation algorithm and a suitable loss function for each of the different training tasks 302A-C.

Thus, FIG. 3 demonstrates how self-generated training data, including action-words 206 and refined video segments 208 can be used in conjunction with existing, large unlabeled video datasets (e.g., 116) to perform supervised learning and to create high-performance models that perform a wide range of tasks. Conventionally, this sort of training would not be possible without a manual process of reviewing and labeling all of the video in large unlabeled video dataset 116, which, when considering very large video datasets, may be practically impossible.

### Example Operations for Refining a Model Trained on Self-Generated Training Data

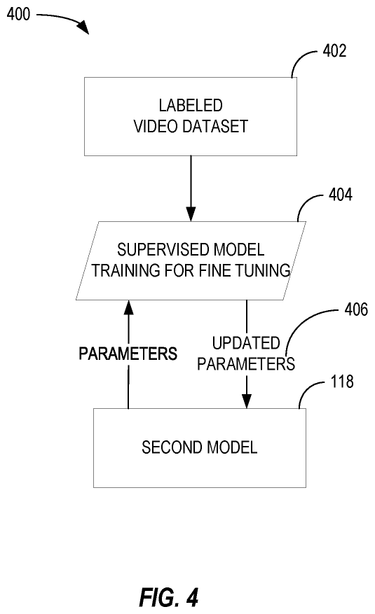

FIG. 4 depicts example operations 400 for refining (or “tuning”) a model initially trained based on self-generated training data, such as action-words and/or refined video segments, as discussed above with respect to FIGS. 1-3.

In this example, second model 118 is further refined based on a supervised training operation 404 using labelled video dataset 402. In some cases, labeled video dataset 402 is the same as labeled video dataset 102 in FIG. 1, which was used to initialize first model 108.

The supervised model training operation 404 generates updated parameters 406 for second model 118, which may generally improve the accuracy of second model 118.

In this way, the benefits of semi-supervised learning using self-generated training data can be augmented with conventional supervised learning using existing, labeled video datasets. The resulting models may generally be more accurate than those trained on relatively small labeled video datasets alone.

### Example Method for Training a Computer Vision Model Using Self-Generated Training Data

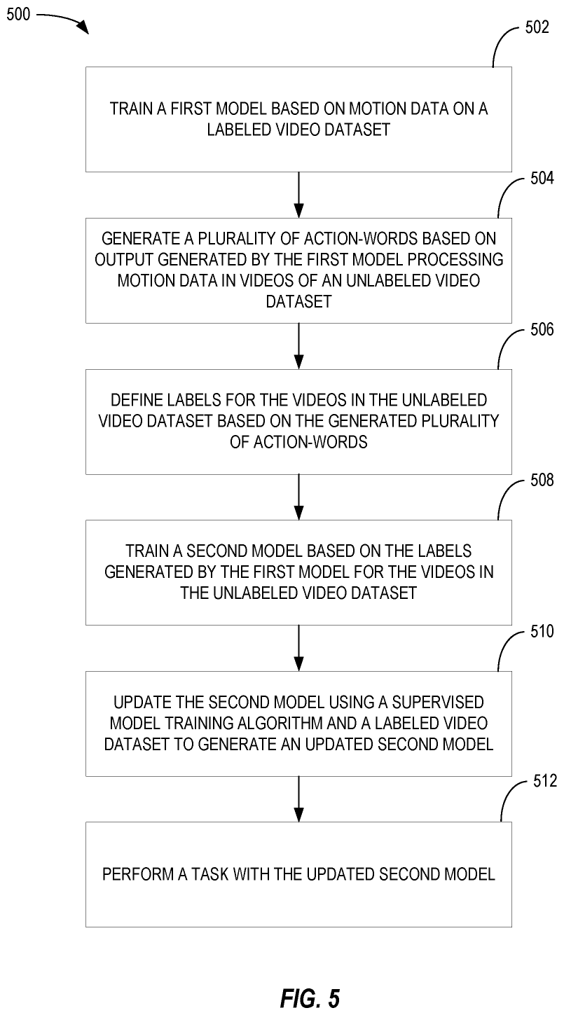

FIG. 5 depicts an example method 500 for training a computer vision model using self-generated training data, such as action-words and video segments, as described above.

Method 500 begins at step 502 with training a first model based on a first labeled video dataset. For example, the first model may be like first model 108 of FIG. 1.

In some embodiments, the first model is trained based on motion data generated from the first labeled video dataset. For example, the motion data may be generated from the underlying video data based on an optical flow process. In other embodiments, the first model is trained based on image data generated from the labeled video dataset.

Method 500 then proceeds to step 504 with generating a plurality of action-words based on output generated by the first model processing motion data in videos of an unlabeled video dataset. For example, the action-words may be created based on the output of the first model, as described with respect to FIG. 2.

In some embodiments, generating the plurality of action-words includes: generating video feature output data from the first model based on the unlabeled video dataset; extracting a plurality of video segments based on the video feature output data; and clustering the plurality of video segments to define the plurality action-words, such as described with respect to FIG. 2. In some embodiments, each action-word of the plurality of action-words represents a centroid of a cluster of video segments.

In some embodiments, method 500 further includes generating refined video segments based on the plurality of action-words and the video feature output data. For example, in some embodiments, generating a plurality of action-words is performed as described in FIG. 2.

In some embodiments, generating the refined video segments based on the plurality of action-words and the video feature output data comprises providing the plurality of action-words and the video feature output data to a localization model and receiving from the localization model the refined video segments, such as described above with respect to FIG. 2. In some embodiments, the localization model comprises a weakly-supervised temporal activity localization model.

In some embodiments, clustering the plurality of video segments to form the plurality of action-words includes using a k-means clustering algorithm with k clusters, and the plurality of action-words comprises k action-words, each associated with a centroid of one of the k clusters.

Method 500 then proceeds to step 506 with defining labels for the videos in the unlabeled video dataset based on the generated action-words, such as described above with respect to FIGS. 1 and 2.

Method 500 then proceeds to step 508 with training a second model based on videos in the unlabeled video dataset and the labels for videos in the unlabeled video dataset, for example, as described above with respect to FIG. 1. In some embodiments, the second model is a convolutional neural network model.

As above, the labels may be based on the output of the first model. In some embodiments, the second model may be trained based on image data for each video in the unlabeled video dataset. In other embodiments, the second model may trained based on motion data for each video in the unlabeled video dataset, such as optical flow data.

Method 500 then proceeds to step 510 with updating the second model using a supervised model training algorithm and a second labeled video dataset to generate an updated second model, such as described with respect to FIG. 4.

In some embodiments, the second labeled video dataset is the same as the first labeled video dataset. In other embodiments, the second labeled video dataset is the same as the first labeled video dataset. In yet other embodiments, the second labeled video dataset may comprise the first labeled video dataset in addition to other labeled video data, such as the merger of multiple labeled video datasets.

Method 500 then proceeds to step 512 with performing a task with the updated second model. In some embodiments, the task is one of classification, localization, or sequence prediction.

Note that updating the second model in step 510 is not necessary in all embodiments, and the second model may be used after initial training to perform tasks. For example, the second model generated in step 508 may perform classification, localization, or sequence prediction tasks (as just a few examples). However, as discussed above, updating the second model based on a labeled video dataset may improve the performance of the second model.

Note that FIG. 5 is just one example of a method, and other methods including fewer, additional, or alternative steps are possible consistent with this disclosure.

### Example Processing System

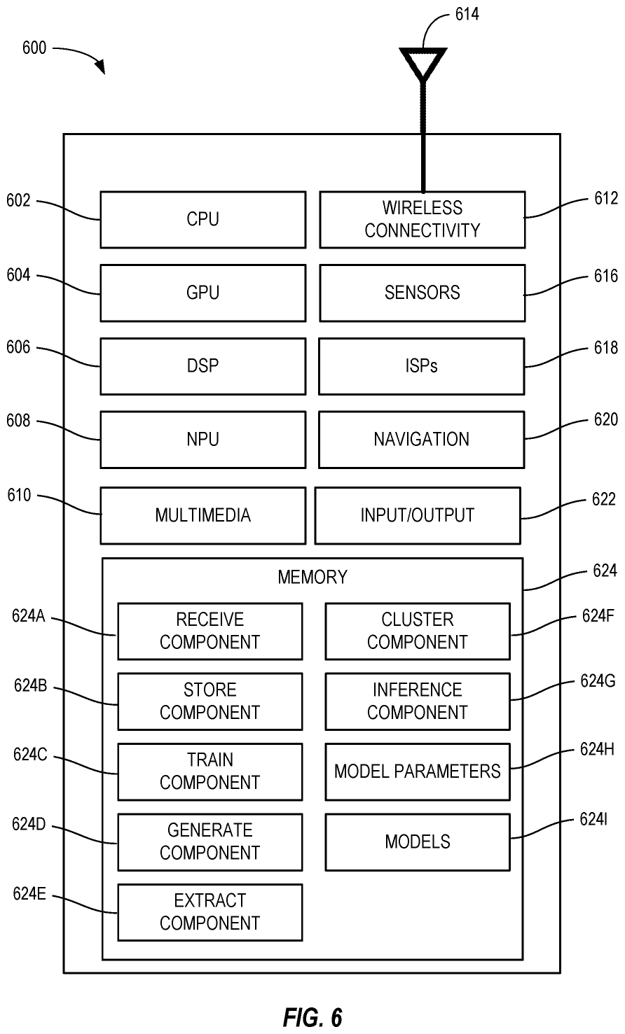

FIG. 6 depicts an example processing system 600 that may be configured to train machine learning models (e.g., computer vision models) as described herein, for example, with respect to FIGS. 1-5.

Processing system 600 includes a central processing unit (CPU) 602, which in some examples may be a multi-core CPU. Instructions executed at the CPU 602 may be loaded, for example, from a program memory associated with the CPU 602 or may be loaded from a memory partition 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as 608, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 612 is further connected to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In this example, memory 624 includes receive component 624A, store component 624B, train component 624C, generate component 624D, extract component 624E, cluster component 624F, inference component 624G, model parameters 624H, and models 6241. The depicted components, and others not depicted, may be configured to perform various aspects of the methods described herein.

Generally, processing system 600 and/or components thereof may be configured to perform the methods described herein, including methods described with respect to FIGS. 1-5.

Notably, in other embodiments, aspects of processing system 600 may be omitted, such as where processing system 600 is a server. For example, multimedia component 610, wireless connectivity 612, sensors 616, ISPs 618, and/or navigation component 620 may be omitted in other embodiments. Further, aspects of processing system 600 maybe distributed among multiple processing units in some embodiments, and therefore various aspects of methods described above may be performed on one or more processing systems.

### Example Clauses

Clause 1: A method of training a computer vision model, comprising: training a first model based on a first labeled video dataset; generating a plurality of action-words based on output generated by the first model processing motion data in videos of an unlabeled video dataset; defining labels for the videos in the unlabeled video dataset based on the generated action-words; and training a second model based on the labels for the videos in the unlabeled video dataset.

Clause 2: The method of Clause 1, wherein generating the plurality of action-words comprises: generating video feature output data from the first model based on the unlabeled video dataset; extracting a plurality of video segments based on the video feature output data; and clustering the plurality of video segments to define the plurality of action-words.

Clause 3: The method of Clause 2, further comprising generating refined video segments based on the plurality of action-words and the video feature output data.

Clause 4: The method of Clause 3, wherein generating the refined video segments comprises providing the plurality of action-words and the video feature output data to a localization model and receiving from the localization model the refined video segments.

Clause 5: The method of Clause 4, wherein the localization model comprises a weakly-supervised temporal activity localization model.

Clause 6: The method of Clause 2, wherein: clustering the plurality of video segments to form the plurality of action-words comprises using a k-means clustering algorithm with k clusters, and the plurality of action-words comprises k action-words.

Clause 7: The method of any one of Clauses 1-6, further comprising: updating the second model using a supervised model training algorithm and a second labeled video dataset to generate an updated second model; and performing a task with the updated second model.

Clause 8: The method of Clause 7, wherein the second labeled video dataset is the same as the first labeled video dataset.

Clause 9: The method of Clause 7, wherein the second labeled video dataset is different from the first labeled video dataset.

Clause 10: The method of Clause 7, wherein the task is one of classification, localization, or sequence prediction.

Clause 11: The method of Clause 6, wherein the updated second model is a convolutional neural network model.

Clause 12: the method of any one of Clauses 1-11, further comprising: performing a task with the second model, wherein the task is one of classification, localization, or sequence prediction.

Clause 13: A processing system, comprising: a memory comprising computer-executable instructions; and one or more processors configured to execute the computer-executable instructions and cause the processing system to perform a method according to any one of Clauses 1-12.

Clause 14: A non-transitory computer-readable medium comprising computer-executable instructions that, when executed by one or more processors of a processing system, cause the processing system to perform a method according to any one of Clauses 1-12.

Clause 15: A computer program product embodied on a computer readable storage medium comprising code for performing the method of any one of Clauses 1-12.

Clause 16: A processing system comprising means for performing a method according to any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training a computer vision model, comprising:
training a first model based on a first labeled video dataset;
generating a plurality of action-words based on output generated by the first model processing motion data in videos of an unlabeled video dataset;
defining labels for the videos in the unlabeled video dataset based on the generated action-words; and
training a second model based on the labels for the videos in the unlabeled video dataset.

2. The method of claim 1, wherein generating the plurality of action-words comprises:
generating video feature output data from the first model based on the unlabeled video dataset;
extracting a plurality of video segments based on the video feature output data; and
clustering the plurality of video segments to define the plurality of action-words.

3. The method of claim 2, further comprising generating refined video segments based on the plurality of action-words and the video feature output data.

4. The method of claim 3, wherein generating the refined video segments comprises providing the plurality of action-words and the video feature output data to a localization model and receiving from the localization model the refined video segments.

5. The method of claim 4, wherein the localization model comprises a weakly-supervised temporal activity localization model.

6. The method of claim 2, wherein:
clustering the plurality of video segments to form the plurality of action-words comprises using a k-means clustering algorithm with k clusters, and
the plurality of action-words comprises k action-words.

7. The method of claim 1, further comprising:
updating the second model using a supervised model training algorithm and a second labeled video dataset to generate an updated second model; and
performing a task with the updated second model.

8. The method of claim 7, wherein the second labeled video dataset is the same as the first labeled video dataset.

9. The method of claim 7, wherein the second labeled video dataset is different from the first labeled video dataset.

10. The method of claim 7, wherein the task is one of classification, localization, or sequence prediction.

11. The method of claim 6, wherein the updated second model is a convolutional neural network model.

12. The method of claim 1, further comprising:
performing a task with the second model,
wherein the task is one of classification, localization, or sequence prediction.

13. A processing system, comprising:
a memory comprising computer-executable instructions; and
a processor configured to execute the computer-executable instructions and cause the processing system to:
train a first model based on a first labeled video dataset;
generate a plurality of action-words based on output generated by the first model processing motion data in videos of an unlabeled video dataset;
define labels for the videos in the unlabeled video dataset based on the generated action-words; and
train a second model based on the labels for the videos in the unlabeled video dataset.

14. The processing system of claim 13, wherein in order to generate the plurality of action-words, the processor is further configured to cause the processing system to:
generate video feature output data from the first model based on the unlabeled video dataset;
extract a plurality of video segments based on the video feature output data; and
cluster the plurality of video segments to define the plurality of action-words.

15. The processing system of claim 14, wherein the processor is further configured to cause the processing system to generate refined video segments based on the plurality of action-words and the video feature output data.

16. The processing system of claim 15, wherein in order to generate the refined video segments, the processor is further configured to cause the processing system to provide the plurality of action-words and the video feature output data to a localization model and receive from the localization model the refined video segments.

17. The processing system of claim 14, wherein:
in order to cluster the plurality of video segments to form the plurality of action-words, the processor is further configured to cause the processing system to use a k-means clustering algorithm with k clusters, and
the plurality of action-words comprises k action-words.

18. The processing system of claim 13, wherein the processor is further configured to cause the processing system to:
update the second model using a supervised model training algorithm and a second labeled video dataset to generate an updated second model; and
perform a task with the updated second model.

19. The processing system of claim 18, wherein the task is one of classification, localization, or sequence prediction.

20. The processing system of claim 13, wherein the processor is further configured to cause the processing system to:
perform a task with the second model,
wherein the task is one of classification, localization, or sequence prediction.

21. A non-transitory computer-readable medium comprising computer-executable instructions that, when executed by one or more processors of a processing system, cause the processing system to perform a method, the method comprising:
training a first model based on a first labeled video dataset;
generating a plurality of action-words based on output generated by the first model processing motion data in videos of an unlabeled video dataset;
defining labels for the videos in the unlabeled video dataset based on the generated action-words; and
training a second model based on the labels for the videos in the unlabeled video dataset.

22. The non-transitory computer-readable medium of claim 21, wherein generating the plurality of action-words comprises:
generating video feature output data from the first model based on the unlabeled video dataset;
extracting a plurality of video segments based on the video feature output data; and
clustering the plurality of video segments to define the plurality of action-words.

23. The non-transitory computer-readable medium of claim 22, wherein the method further comprises generating refined video segments based on the plurality of action-words and the video feature output data.

24. The non-transitory computer-readable medium of claim 23, wherein generating the refined video segments comprises providing the plurality of action-words and the video feature output data to a localization model and receiving from the localization model the refined video segments.

25. The non-transitory computer-readable medium of claim 24, wherein the localization model comprises a weakly-supervised temporal activity localization model.

26. The non-transitory computer-readable medium of claim 22, wherein:
clustering the plurality of video segments to form the plurality of action-words comprises using a k-means clustering algorithm with k clusters, and
the plurality of action-words comprises k action-words.

27. The non-transitory computer-readable medium of claim 21, wherein the method further comprises:
updating the second model using a supervised model training algorithm and a second labeled video dataset to generate an updated second model; and
performing a task with the updated second model.

28. The non-transitory computer-readable medium of claim 27, wherein the task is one of classification, localization, or sequence prediction.

29. The non-transitory computer-readable medium of claim 21, wherein the method further comprises:
performing a task with the second model,
wherein the task is one of classification, localization, or sequence prediction.
